(19) United States
(12) Patent Application Publication
(10) Pub. No.: US 2006/0081646 A1
(43) Pub. Date: Apr. 20, 2006

(54) Cap with push type opener

(76) Inventor: Hee Kwon Rho, Kyungki-do (KR)

Correspondence Address: OSTROLENK FABER GERB & SOFFEN, 1180 AVENUE OF THE AMERICAS, NEW YORK, NY, 100368403, US

(21) Appl. No.: 10/536,264

(22) PCT Filed: Dec. 5, 2003
(86) PCT No.: PCT/KR03/02666

§ 371 Date: May 24, 2005

(30) Foreign Application Priority Data
Dec. 5, 2002 (KR) 10-2002-0077117
Nov. 21, 2003 (KR) 10-2003-0083209

(51) Int. Cl. B67D 5/00

(52) U.S. Cl. 222/80; 222/145.1; 222/192

(57) ABSTRACT

Disclosed is a cap (20) provided with a push type opener. The cap includes a cap main body (21) detachably connected to an entrance of a container (10), and an opener (30) provided on the cap main body (21) such that the opener (30) moves down by user's push-type operation so as to open a sealing member (15) provided on the entrance of the container (10) or in the cap main body (21) for sealing the container (10). The sealing member (15) is simply removed using the opener (30) without direct contact by a user's hand, thus allowing contents in the container (10) to sanitarily flow out and causing contents in the container (20) cap to be conveniently mixed with the contents in the container (10).

### TECHNICAL FIELD

The present invention relates to a cap for a container, and more particularly to a cap provided with a push type opener, in which a sealing member is detached from an entrance of a container or the cap.

### BACKGROUND ART

FIG. 1 is a cross-sectional view of a cap, provided with a conventional opening structure, for a beverage container.

The cap provided with the conventional opening structure comprises a cap main body 3 detachably connected to an entrance of a container 1 sealed by a sealing member 2, an elevating member 4 installed at the external surface of an upper portion of the cap main body 3 such that the elevating member 4 can move up and down, and a subsidiary cap 5 covering the upper portion of the cap main body 3.

When a user wants to drink the beverage contained in the container 1 provided with the cap, the cap main body 3 is detached from the container 1, and the sealing member 2 is removed from the entrance of the container 1. Then, the cap main body 3 is attached to the entrance of the container 1, and the subsidiary lid 5 is opened and the elevating member is pulled upwards by a user's hand. Thereby, an upper portion 4′ of the elevating member 4 is separated from a head portion 3′ of the cap main body 3, thus opening the entrance of the container 1 and allowing the user to drink the beverage exhausted from the tilted container 1.

In case that the user does not want to drink beverage contained in the container 1, the user presses the elevating member 4 by hand so that the elevating member 4 is returned to its earlier position, thus closing the entrance of the container 1.

Since, in order to open the cap provided with the conventional opening structure from the container 1, the cap main body 3 is detached from the container, the sealing member 2 is removed from the entrance of the container 1, and then the cap main body 3 is attached again to the container 1, it causes inconvenience to users.

Particularly, since the sealing member 2 is firmly attached to the entrance of the container 1 for sealing the container 1, it is not easy to detach the sealing member 2 from the container 1. Further, since most of the conventional sealing members 2 are detached from the container 1 by means of the user's hands, the entrance of the container 1 is contaminated by the user's hands when the sealing member 2 is detached from the container 1, thus causing unsanitary conditions to the beverage contained in the container 1.

It is difficult to store additional contents separately from the contents contained in the container 1 provided with the above-described conventional cap, thus causing the container 1 to require an additional container or the cap to have a complicated structure.

When a user wants to drink the beverage contained in the container 1 provided with the above-described conventional cap, the elevating member 4 is pulled upwards so that the cap is opened from the entrance of the container 1, and after the user drinks the beverage contained in the container 1, the elevating member 4 is pushed into its earlier position by the user's hands, thus contaminating the entrance of the container 1 and causing poor sanitary conditions.

### DISCLOSURE OF THE INVENTION

Therefore, the present invention has been made in view of the above problems, and it is an object of the present invention to provide a cap provided with a push type opener, in which a sealing member for closing an entrance of a container is opened by a push-type operation without the separation of a cap main body from the container, thus allowing the container to be sanitarily opened and causing the sealing member to be conveniently removed.

It is another object of the present invention to provide a cap provided with a push type opener, in which beverages or foods are individually stored by each of the cap and a container, and are then mixed by opening a sealing member by a push-type operation, thus allowing the contents in the container and the cap to be simply stored and mixed, and improving the convenience of users.

In accordance with one aspect of the present invention, the above and other objects can be accomplished by the provision of a cap provided with a push type opener, comprising: a cap main body detachably connected to an entrance of a container; and an opener provided on the cap main body such that the opener moves down by user's push-type operation so as to open a sealing member provided on the entrance of the container or in the cap main body for sealing the container.

Preferably, the opener having a two-stage structure may be connected to an upper portion of the cap main body, and the cap main body may include an external wall portion extended from the circumference of the opener and selectively opened at at least a part thereof.

Further, preferably, the cap main body may further include a cap cover for closing the opened part; a storing portion in a gap between the cap cover and the opener for storing a spoon or a straw; a protrusion for receiving the cap cover; and a protrusion for receiving the storing portion, the protrusions being continuously formed.

Moreover, preferably, the opener may have a dome-type structure reversibly mounted in the cap main body.

Preferably, the opener may include: a tension plate located at a central area of the dome-type structure; a cutting member extended from a lower portion of the tension plate for opening the sealing member; and a connecting member connected from the cutting member to the inside of the tension plate for vertically moving the cutting member.

Further, preferably, the tension plate may have a plate type structure having a thickness thicker than that of the connecting member.

Moreover, preferably, the cutting member may selectively cut the sealing member so that a part of the sealing member is not cut and remains.

Preferably, a pushing rod for pushing the sealing member cut by the cutting member in one direction may be provided on the lower portion of the tension plate.

Preferably, the connecting member may have a bellows structure.

Further, preferably, the sealing member may be installed in the cap main body for sealing the inside of the opener.

Moreover, preferably, the cutting member may be formed along the external circumference of the entrance of the container. In case that that the entrance of the container has a circular shape, the cutting member has a circular shape.

Preferably, the pushing rod may have a cross-shaped cross section, and a pushing rod for pushing the sealing member cut by the cutting member in one direction may be provided on the lower portion of the tension plate, and be protruded from at least one space out of spaces crosswise divided by the cutting member.

Further, preferably, the cutting member may be designed such that it opens the sealing member by perforating the sealing member at plural areas. More preferably, the cutting member may be designed such that it perforates the sealing member at two areas, and one hole of the obtained two holes may have a size larger than that of the other hole of the obtained two holes.

In accordance with another aspect of the present invention, there is provided a cap provided with a push type opener, comprising: a cap main body detachably connected to an entrance of a container; and an opener provided on the cap main body such that the opener opens the sealing member by pushing the cap main body deeply into the container.

The sealing member for closing the entrance of the container is opened by a push-type operation without the separation of the cap main body from the container, thus allowing the entrance of the container to be easily opened and causing the contents to sanitarily flow out.

Further, beverages or foods are individually stored by each of the cap and a container, and are then mixed by opening the sealing member by a push-type operation, thus allowing the contents in the container and the cap to be simply stored and mixed, and improving the convenience of users.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a cap, provided with a conventional opening structure, for a beverage container;

FIG. 2 is a perspective view of a cap, provided with a push type opener, for a beverage container in accordance with a first embodiment of the present invention;

FIG. 3 is a plan view of the cap, provided with the push type opener, in accordance with the first embodiment of the present invention;

FIG. 4 is a cross-sectional view of the cap, taken along the line A-A in FIG. 3, which is attached to the beverage container;

FIG. 5 is a cross-sectional view of the cap, taken along the line A-A in FIG. 3, which is detached from the beverage container;

FIG. 6 is a bottom view of the cap, provided with the push type opener, in accordance with the first embodiment of the present invention;

FIG. 7 is a longitudinal-sectional view of a cap, provided with a push type opener, in accordance with a second embodiment of the present invention;

FIG. 8 is a bottom view of a cap, provided with a push type opener, in accordance with a third embodiment of the present invention;

FIG. 9 is a cross-sectional view of the cap, taken along the line B-B in FIG. 8;

FIG. 10 is a bottom view of a cap, provided with a push type opener, in accordance with a fourth embodiment of the present invention; and

FIG. 11 is a longitudinal-sectional view of a cap, provided with a push type opener, in accordance with a fifth embodiment of the present invention.

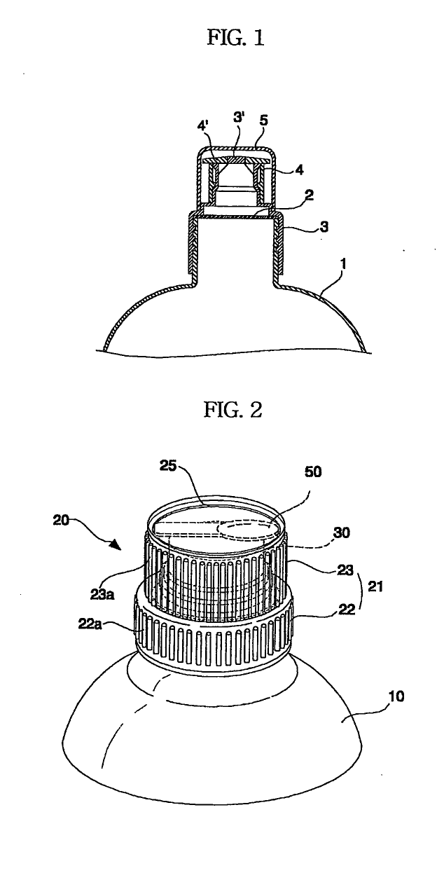

### BEST MODE FOR CARRYING OUT THE INVENTION

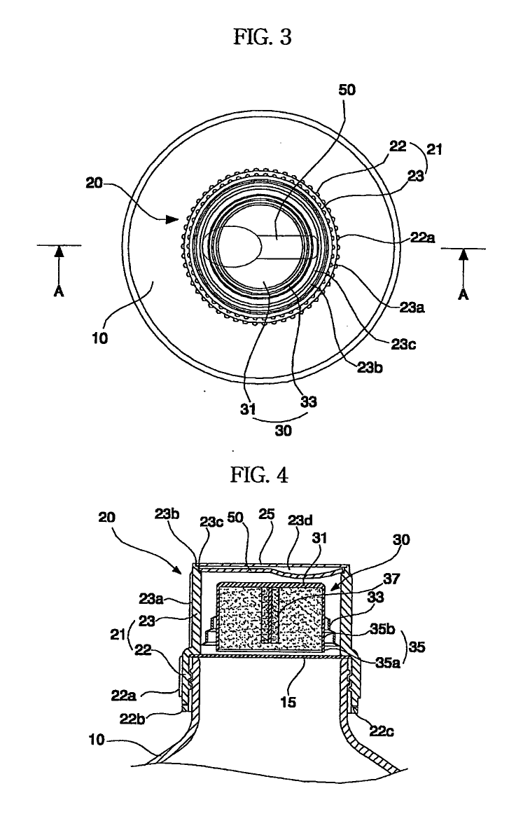

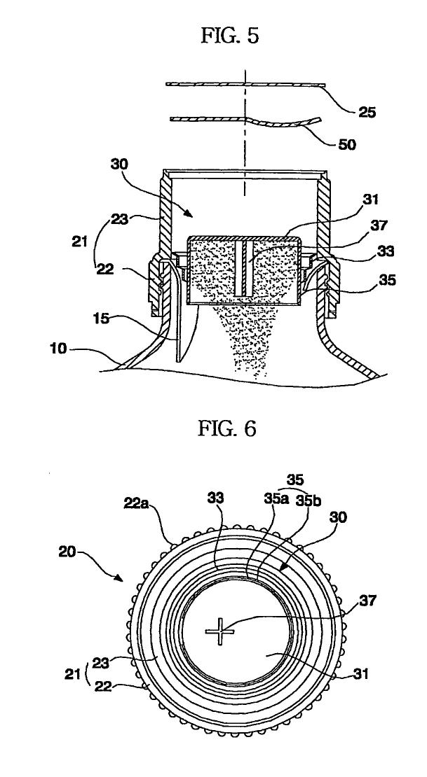

FIGS. 2 to 6 illustrate a cap, provided with a push type opener, for a beverage container in accordance with a first embodiment of the present invention. More particularly, FIG. 2 is a perspective view of the cap, FIG. 3 is a plan view of the cap, FIG. 4 is a cross-sectional view of the cap, taken along the line A-A in FIG. 3, which is attached to the beverage container, FIG. 5 is a cross-sectional view of the cap, taken along the line A-A in FIG. 3, which is detached from the beverage container, and FIG. 6 is a bottom view of the cap.

As shown in FIGS. 2 to 4, the cap 20 in accordance with the first embodiment of the present invention comprises a cap main body 21 detachably attached to an entrance of a container 10, and an opener 30 provided on the cap main body 21 such that the opener 30 moves down by user's push-type operation and opens a sealing member 15 provided on the entrance of the container 10 for sealing the container 10.

That is, the opener 30 of the cap 20 is connected to the cap main body 21 in a two-stage structure so that the sealing member 15 is opened by pushing the opener 30.

Hereinafter, constitution of the cap 20 in accordance with the first embodiment of the present invention will be described in detail.

First, the cap main body 21 includes a connector portion 22 screwed to the entrance of the container 10, and an external wall portion 23 extended from the connector portion 22 upwards and provided with an opened upper surface. Here, the opener 3 is located in the external wall portion 23.

The connector portion 22 is provided with knurls 22a formed on the external surface thereof so that cap 20 is easily opened from the container 10. Further, the connector portion 22 is provided with a sealing portion 22b, a joint portion 22c and a cutting portion (not shown) formed on the lower portion thereof so as to protect the contents in the container 10.

The external portion 23 serves to protect the opener 30 from external impact, and is provided with knurls 23a formed on the external surface thereof so that the cap 20 is easily opened from the container 10.

The opened upper surface of the external wall portion 23 is closed by a cap cover 25, which exhibits advertisement of a product. A gap between the cap cover 25 and the opener 30 serves as a storing portion 23d for storing an eating or drinking tool such as a spoon 50 or a straw. Preferably, a protrusion 23b for receiving the cap cover 25 and a protrusion 23c for receiving the storing portion 23d are continuously formed on the opened upper surface of the external wall portion 23.

In case that the storing portion 23d of the cap main body 21 has a comparatively small volume, the spoon 50 has a foldaway structure.

The opener 30 has a dome-type structure, which is reversibly mounted in the external wall portion 23 of the cap main body 21.

The opener 30 includes a tension plate 31 located at a central area of a dome-type structure thereof and pressed by user's hand, a cutting member 35 extended from the lower portion of the tension plate 31 for opening the sealing member 15, and a connecting member 33 connected to the tension plate 31 or the cutting member 35 and located in the external wall portion 23 for vertically moving the cutting member 35.

The tension plate 31 has a plate type structure having a thickness thicker than that of the connecting member 33.

The cutting member 35 includes a supporter 35b extended from the tension plate 31 downwards, and a cutting blade 35a formed on the end of the supporter 35b and sharpened for easily cutting the sealing member 15. Preferably, as shown in FIG. 6, the cutting blade 35a is formed on a part of the end of the supporter 35b so that the sealing member 15 is selectively cut by the cutting blade 35a. Here, the cutting blade 35a has various shapes such as a sward shape, a saw-teeth shape etc.

Further, the cutting member 35 is formed along the external circumference of the entrance of the container 10. In case that the entrance of the container 10 has a circular shape, the cutting member 35 also has a circular shape. As described above, the cutting member 35 has an opened circular shape provided with a part in which the cutting blade 35a or the supporter 35b is not formed.

The connecting member 33 has a thickness thinner than that of the tension plate 31 and a transversal bellow-type structure so that the connecting member 33 is easily folded and reversed.

Preferably, the tension plate 31 is provided with, at the lower portion thereof, a pushing rod 37 for pushing the sealing member 15 cut by the cutting member 35 in one direction.

The pushing rod 37 has a cross-shaped cross section, as shown in FIG. 6, and is protruded from an eccentric area of the lower portion of the tension plate 31 close to the non-cut portion of the sealing member 15 so that the cut sealing member 15 is easily pushed aside.

Alternately, the pushing rod 37 may be protruded from the central area of the lower portion of the tension plate 31, or may be formed in various shapes and structures according to design conditions.

Now, operation and function of the cap 20 in accordance with the first embodiment of the present invention will be described in detail.

When a user separates the cap cover 25 and the spoon 50 from the container 10 under the state as shown in FIG. 4, and presses the tension plate 31 of the opener 30 by his/her hand, the opener 30 vertically moves down. Then, as shown in FIG. 5, the cutting member 35 moves down, and cuts the sealing member 15 closing the entrance of the container 10, thus opening the entrance of the container 10.

Here, the cut portion of the sealing member 15 is pushed toward a non-cut portion thereof, located under the portion of the cutting member 35 without the cutting blade 35a, by the descending pushing rod 37.

The inside of the opener 30, which was located on the sealing member 15, and the inside of the container 10, which was located under the sealing member 15, are connected to each other. Accordingly, contents contained in the opener 30 falls into the inside of the container 10, thus being mixed with contents contained in the container 10.

Thereafter, when the container 10 is shaken so that the mixed contents are well blended, the cap 20 is opened from the container 10 in the same manner as that of the conventional cap, and then the user drinks or spoons the mixed contents in the container 10 or pours the mixed contents out of the container 10 into another container.

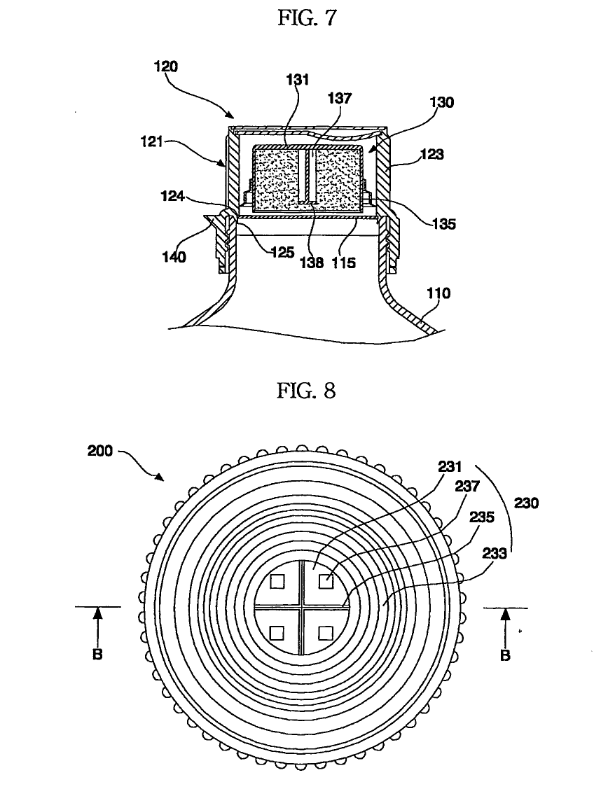

FIG. 7 is a longitudinal-sectional view of a cap, provided with a push type opener, in accordance with a second embodiment of the present invention.

The cap 120 in accordance with the second embodiment of the present invention comprises a sealing member 115 provided in a cap main body 121, whereas the cap 20 in accordance with the first embodiment of the present invention comprises the sealing member 15 provided on the entrance of the container 10.

That is, in case that the sealing member 115 is installed in the cap main body 121, a sealing member reception protrusion 124 is formed on the lower end of an external wall portion 123, and a Crab's claw 125 is protruded from the lower end of the external wall portion 123 to the inside of the entrance for cutting off contents contained in a container 110 from external environment, thus preventing the contents from contaminating.

In case that the sealing member 115 is installed in the cap main body 121 as described above, the contents such as beverage or food are easily stored in an opener 130.

A pushing plate 138, which is in surface-contact with the sealing member 115, is provided on a cross-shaped pushing rod 137 of the opener 130, and a opening grip 140 is protruded from the external surface of the cap main body 121, thus allowing a user to easily open the cap from the container 10.

When the user presses a tension plate 131 of the opener 130 by his/her hand, a cutting member 135 moves down, and cuts the sealing member 115 provided in the cap main body 121 so that the inside of the opener 130 and the inside of the container 110 are connected to each other.

Accordingly, contents contained in the opener 130 fall into the inside of the container 110, thus being mixed with contents contained in the container 110. Then, after the opening grip 140 is pushed in so that the cap 120 is detached from the container 110, the mixed contents in the container 110 are taken out.

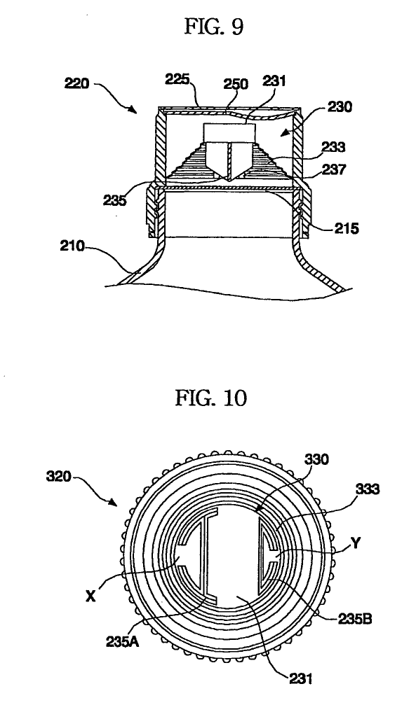

FIG. 8 is a bottom view of a cap, provided with a push type opener, in accordance with a third embodiment of the present invention. FIG. 9 is a cross-sectional view of the cap, taken along the line B-B in FIG. 8.

The cap 220 in accordance with the third embodiment of the present invention comprises a cutting member 235 having a cross-shaped cross section and a pushing rod 237 is protruded from at least one space out of spaces crosswise divided by the cutting member 235, whereas the cap 20 in accordance with the first embodiment of the present invention comprises the cutting member 35 having a circular structure.

Preferably, the cutting member 235 is provided with a V-shaped end so that the sealing member 215 is cut starting from the central area thereof to the edge area thereof, and four pushing rods 237 are respectively formed at spaces divided in the cross-shapes.

Here, reference numeral 233 represents a connector portion having a bellows structure. Elements of the cap 220, other than the cutting element 235 and the pushing rod 237, of the third embodiment are the same as those of the first embodiment, and their detailed descriptions will thus be omitted.

Now, operation and function of the cap 220 in accordance with the third embodiment of the present invention will be described in detail.

When a user separates the cap cover 225 and the spoon 250 from the container 210, and presses the tension plate 231 of the opener 230 by his/her hand, the opener 230 vertically moves down. Then, as shown in FIG. 5, the cutting member 235 moves down, and cuts the sealing member 215 closing the entrance of the container 210, thus opening the entrance of the container 210.

That is, the sealing member 215 is cut into a cross-shaped structure by the cutting member 235, and the cut portions of the sealing member 215 are expanded by the pushing rod 237 and pushed toward the inner wall of the entrance. Here, the inside of the opener 230, which was located on the sealing member 215, and the inside of the container 210, which was located under the sealing member 215, are connected to each other. Accordingly, contents contained in the opener 230 fall into the inside of the container 210, thus being mixed with contents contained in the container 210.

FIG. 10 is a bottom view of a cap, provided with a push type opener, in accordance with a fourth embodiment of the present invention.

The cap 320 in accordance with the fourth embodiment of the present invention comprises a plurality of cutting members 335A and 335B for cutting plural portions of a sealing member, whereas each of the caps 20, 120 and 220 in accordance with the first, second and third embodiments of the present invention comprises the corresponding one of the cutting members 35, 135 and 235.

That is, with reference to FIG. 10, the cap 320 comprises the two cutting members 335A and 335B for cutting two portions of the sealing member. Here, one cutting member 335A has a size larger than that of the other cutting member 335B.

Preferably, the above-described two cutting members 335A and 335B are respectively protruded from the tension plate 310 of the opener 330 so that two holes, arranged at an angle of 180 degrees, are formed through the sealing member. The cutting members 335A and 335B respectively have opened structures provided with openings X and Y so that the cut portions of the sealing member are connected to the sealing member.

Here, reference numeral 333 represents a connector portion having a bellows structure. Elements of the cap 320, other than the cutting elements 335A and 335B, of the fourth embodiment are the same as those of the first embodiment, and their detailed descriptions will thus be omitted.

In above-described cap 320 in accordance with the fourth embodiment of the present invention, a comparatively large one of the two cutting portions of the sealing member formed by the cutting members 335A and 335B serves as a hole, through which a user drinks or pours the contents, and a comparatively small one of the two cutting portions of the sealing member formed by the cutting members 335A and 335B serves as a hole, through which air is introduce into the container so as to assist the contents to easily flow out of the larger hole.

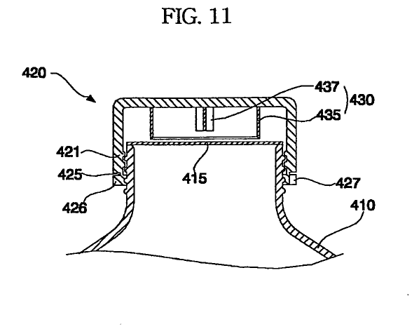

FIG. 11 is a longitudinal-sectional view of a cap, provided with a push type opener, in accordance with a fifth embodiment of the present invention.

The cap 420 in accordance with the fourth embodiment of the present invention comprises a cap main body 421 detachably attached to an entrance of a container 410, and an opener 430 provided on the cap main body 421 such that the opener 430 connects the cap main body 421 more deeply into the container 410, thus opening a sealing member 415 provided on the entrance of the container 10 for sealing the container 10

That is, when the cap 420, which is first connected to the entrance of the container 410 is further rotated in a direction that the cap 420 is locked into the container 410, the cap 420 is secondarily connected to the container 410 more deeply and a cutting member 435 installed in the cap main body 421 moves down and cuts the sealing member 415, thus opening the container 410.

The opener 430 includes the cutting member 435, and a pushing rod 437 located at the central area of the cutting member 435.

Particularly, a rotation preventing member for preventing the rotation of the cap main body 421 is interposed between the first and second connection portions of the cap main body 321 and the entrance of the container 410, thereby preventing the cap main body 421 from rotating until force having a designated degree or more is applied to the rotation preventing member.

Preferably, the rotation preventing member includes a sealing portion 426 having a circular ring shape connected to the lower end of the cap main body 421 through a plurality of joints 425, and a cutting portion 427 cut by applying force having a designated degree or more to the sealing portion 426. When the cap main body 421 is rotated by the force having the designated degree or more, portions of the sealing portion 426 not provided with a female thread are caught by portions of the entrance of the container 410 provided with a male thread, thus cutting the connection between the cutting portion 427 and the joints 425.

Accordingly, the cap main body 421 is rotated more deeply into the entrance of the container 410, and the sealing member 415 is opened by the opener 430.

### INDUSTRIAL APPLICABILITY

As apparent from the above description, the present invention provides a cap provided with a push type opener, in which a sealing member for closing an entrance of a container is opened by a push-type operation, thus eliminating inconvenience that the cap is separated from the container for removing the sealing member before contents flows out of the container.

Further, an entrance of the container is easily opened without direct contact by a user's hand at the entrance, thus allowing contents in the container to sanitarily flow out.

Moreover, beverages or foods are individually stored by each of the cap and a container, and are then mixed by opening the sealing member by a push-type operation, thus allowing the contents in the container and the cap to be conveniently mixed and causing users to simply eat or drink the mixed contents.

Furthermore, since a spoon or a straw is stored in a gap in the cap, the cap container of the present invention allows the users to conveniently use the spoon or the straw when they eat or drink the contents, and since the cap is provided with a cap cover, the cap cover has advertisement effects and prevents foreign substances from being introduced into the cap, thus improving the purity of the spoon or the straw.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

For example, the cap provided with the push type opener in accordance with the present invention is applied to containers and caps, which are sealing-treated, regardless of types of the contents of the container. Particularly, the cap of the present invention is applied to an assembly comprising two containers provided with sealing members.

1. A cap provided with a push type opener, comprising:
a cap main body detachably connected to an entrance of a container; and
an opener provided on the cap main body such that the opener moves down by user's push-type operation so as to open a sealing member provided on the entrance of the container or in the cap main body for sealing the container.

2. The cap as set forth in claim 1,
wherein the opener having a two-stage structure is connected to an upper portion of the cap main body.

3. The cap as set forth in claim 2,
wherein the cap main body includes an external wall portion extended from the circumference of the opener and selectively opened at at least a part thereof.

4. The cap as set forth in claim 3,
wherein the cap main body further includes a cap cover for closing the opened part thereof.

5. The cap as set forth in claim 3,
wherein the cap main body further includes a storing portion in the opened part for storing a spoon or a straw.

6. The cap as set forth in claim 3,
wherein the cap main body includes:
a cap cover for closing the opened part;
a storing portion in a gap between the cap cover and the opener for storing a spoon or a straw;
a protrusion for receiving the cap cover; and
a protrusion for receiving the storing portion, said protrusions being continuously formed.

7. The cap as set forth in claim 1,
wherein the opener has a dome-type structure reversibly mounted in the cap main body.

8. The cap as set forth in claim 7,
wherein the opener includes:
a tension plate located at a central area of the dome-type structure;
a cutting member extended from a lower portion of the tension plate for opening the sealing member; and
a connecting member connected from the cutting member to the inside of the tension plate for vertically moving the cutting member.

9. The cap as set forth in claim 8,
wherein the tension plate has a plate type structure having a thickness thicker than that of the connecting member.

10. The cap as set forth in claim 8,
wherein the cutting member selectively cut the sealing member so that a part of the sealing member is not cut and remains.

11. The cap as set forth in claim 8,
wherein a pushing rod for pushing the sealing member cut by the cutting member in one direction is provided on the lower portion of the tension plate.

12. The cap as set forth in claim 8,
wherein the cutting member is formed along the external circumference of the entrance of the container.

13. The cap as set forth in claim 12, wherein:
the entrance of the container has a circular shape, and the cutting member has a circular shape.

14. The cap as set forth in claim 8,
wherein the pushing rod has a cross-shaped cross section.

15. The cap as set forth in claim 14,
wherein a pushing rod for pushing the sealing member cut by the cutting member in one direction is provided on the lower portion of the tension plate, and is protruded from at least one space out of spaces crosswise divided by the cutting member.

16. The cap as set forth in claim 8,
wherein the cutting member is designed such that it opens the sealing member by perforating the sealing member at plural areas.

17. The cap as set forth in claim 16, wherein:
the cutting member is designed such that it perforates the sealing member at two areas; and
one hole of the obtained two holes has a size larger than that of the other hole of the obtained two holes.

18. The cap as set forth in claim 8,
wherein the connecting member has a bellows structure.

19. The cap as set forth in claim 1, wherein;
the opener has a dome-type structure reversibly mounted in the cap main body; and
the sealing member is installed in the cap main body for sealing the inside of the opener.

20. A cap provided with a push type opener, comprising:
a cap main body detachably connected to an entrance of a container; and
an opener provided on the cap main body such that the opener opens
the sealing member by pushing the cap main body deeply into the container.
